(19) United States
(12) Patent Application Publication
(10) Pub. No.: US 2025/0062635 A1
(43) Pub. Date: Feb. 20, 2025

(54) ENERGY EFFICIENT ENERGY STORAGE CYCLING AND CHARACTERIZATION SYSTEM

(71) Applicant: The Board of Trustees of The University of Alabama, Tuscaloosa, AL (US)

(72) Inventor: Jaber A. Abu Qahouq, Tuscaloosa, AL (US)

(21) Appl. No.: 18/738,168

(22) Filed: Jun. 10, 2024

Related U.S. Application Data
(60) Provisional application No. 63/519,304, filed on Aug. 14, 2023.

(51) Int. Cl. H02J 7/34; H02J 7/00

(52) U.S. Cl. CPC H02J 7/342; H02J 7/0013; H02J 7/0048; H02J 7/00714; H02J 7/007182

(57) ABSTRACT

Methods and systems for characterization of batteries and other storage devices that may be new or second use. The systems charge and discharge the storage devices to measure capacity, charge and discharge current and voltage curves, impedance, and/or temperature variations, among others. During charging of one storage device, energy is dissipated from another storage device, and vice versa. As such, the power that is consumed from the grid by each storage device and/or dissipated through a load is greatly reduced providing increased efficiency.

### CROSS-REFERENCE TO RELATED APPLICATION

This application claims priority to U.S. Provisional Patent Application No. 63/519,304, file Aug. 14, 2023, entitled “ENERGY EFFICIENT ENERGY STORAGE CYCLING AND CHARACTERIZATION SYSTEM,” which is expressly incorporated herein by reference in its entirety.

### FEDERALLY SPONSORED RESEARCH AND DEVELOPMENT

This invention was made with government support under contract #2213918; Fund #GR28948 awarded by the National Science Foundation. The government has certain rights in the invention.

### BACKGROUND

A concern is the growing number of batteries that are used in every electric vehicle (frequently referred to by Second-Use Batteries or Second-Life Batteries). Often these are lithium-ion batteries containing cobalt, nickel, manganese, lithium and other material or components that can contaminate soil and water supplies if not properly recycled. Typically, batteries no longer meet the demands of electric vehicles when their state of health is below ˜70-80%. At this point, the batteries are often replaced. However, these batteries still may be used in other less demanding environments, before their material can be recycled.

Characterization of batteries, new or second use (such as those retired from Electric Vehicles/EVs or other applications), requires charging the and discharging them to measure capacity, charge and discharge current and voltage curves, impedance, and/or temperature variations, among others. During charging, power is consumed for example from the grid by each battery and during discharging power is dissipated through a load and wasted. Another option is to send the power during discharge back to the grid. All these options require high power source and/or load installations, expensive hardware, and they are inefficient.

Battery grading is a growing industry. There is a need in the battery grading market due to the increase utilization in applications such as electrified transportation, renewable energy storage and power grid support.

### SUMMARY

The present disclosure describes systems and methods for implementing and controlling systems that is/can be used to characterize energy storage devices. In accordance with an aspect, a method for characterizing a plurality of energy storage devices is disclosed. The method includes discharging a first storage device into a second storage device to charge the second storage device while measuring discharging characteristics of the first storage device and the charging characteristics of the second storage device; discharging the second storage device into the first storage device to charge the first storage device while measuring charging characteristics of the first storage device and the discharging characteristics of the second storage device; and providing energy from a power source, as needed, by the first storage device or the second storage device in order to perform the characterizing.

Associated circuit realizations to perform the method are also disclosed.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. To illustrate the implementations, there are shown in the drawings example constructions; however, the implementations are not limited to the specific methods and instrumentalities disclosed. In the drawings:

FIG. 1 illustrates example block diagrams using two batteries;

FIG. 2 shows an example circuit realization for two batteries;

FIG. 3 shows an example realization for more than two batteries (N batteries);

FIG. 4 shows an example controller;

FIG. 5 shows another example controller that records response data to determine additional characteristics of the batteries; and

FIG. 6 shows another example circuit realization for N batteries.

### DETAILED DESCRIPTION

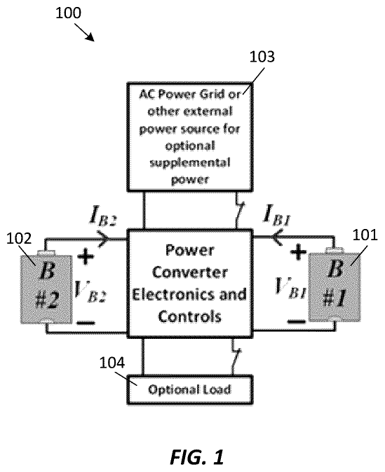

The present disclosure describes methods and systems that greatly enhance the process and efficiency for characterizing batteries and other storage devices. With reference to FIG. 1 there is shown a system 100 where two batteries (101, 102) that are being graded or characterized can be used as a source and a load for each other. During a characterization process of battery 101, when it is discharged, its energy is stored in battery 102, which may also be characterized at the same time while charging from battery 101. Storing the energy from battery 101 in battery 102 eliminates wasteful dissipation of energy from battery 101 into a load 104 or return the energy an AC power grid 103. This way both batteries 101, 102 can be characterized at the same time, i.e., one is characterized while discharging into the other and the other is characterized while charging from the first. Thus, the energy being used for the characterization is recycled between the two batteries 101, 102. Moreover, most of the energy is not dissipated, except for the power loss through the power electronics, e.g., 2%-10%. It follows from the above that during characterization using a discharging process of battery 102, its energy is stored in battery 101 that is also being characterized instead dissipating its of energy into the load 104 or return the energy he AC power grid 103.

In accordance with the operation of system 100, there may be a small energy loss associated with the charging and discharging of the batteries 101, 102 into each other. Also, the batteries 101, 102 might not have equal capacities, for example due to aging or difference in temperature. Therefore, a small energy source can be obtained from the AC power grid 103 to cover this loss. Similarly, the load 104 may also be available to dissipate any small additional energy.

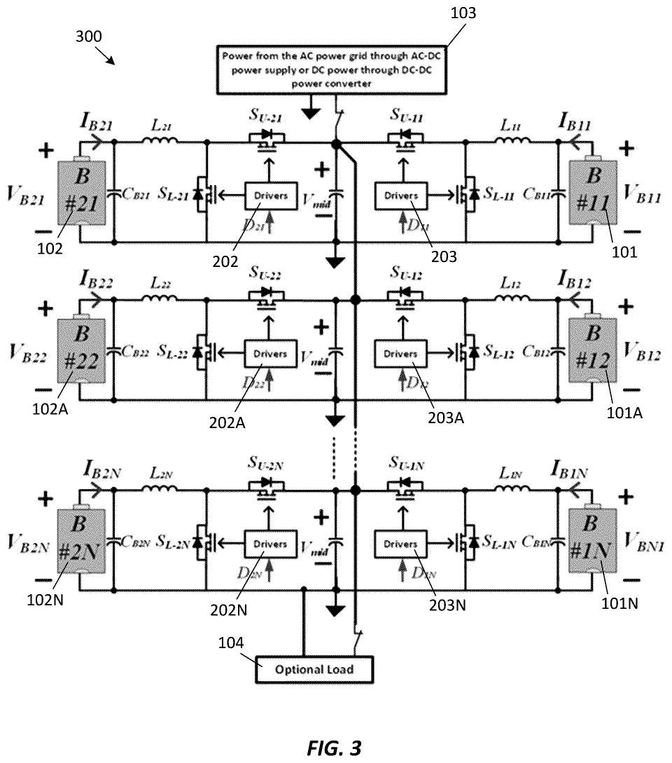

As shown in FIG. 3, there is a system 300 that includes more than two batteries 101, 102, 101A, 102A . . . 101N, 102N. The system 300 is more efficient and increases the speed at which batteries can be characterized as energy can be dissipated or retrieved from all of the batteries 101, 102, 101A, 102A . . . 101N, 102N under characterization.

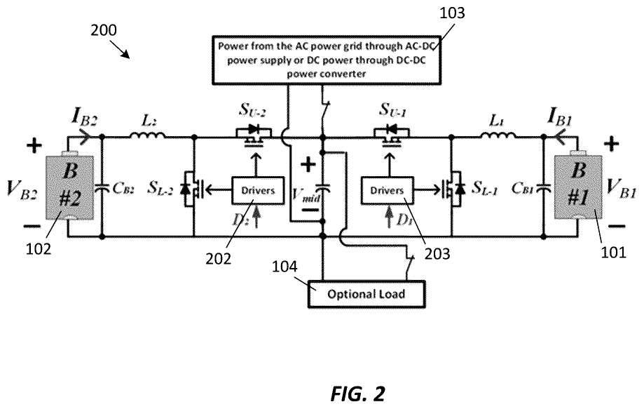

With reference to FIGS. 2, 3 and 4, there is illustrated an example circuit realization 200, 300 of the system 100 and an example controller 400. The controller 400 advantageously allows for different current references for battery 101 and battery 102 (and 101A, 102A . . . 101N, 102N) by incorporating drives 202, 203.

The several modes of operation are contemplated, as follows:

Control Method when Battery 101 Discharges into Battery 102 (402)—This is analogous to when battery 102 charges from battery 101. A closed control loop 404 regulates I_{B2} during constant current (CC) charging mode of battery 102 to a desired value −I_{B2-CH-ref} by generating duty cycle D2 control signal. A second control closed loop 408 regulates current I_{B1} to a second desired discharging current value +I_{B1-DCH-ref}. However, in order to be able to regulate at two current values and/or with two different battery voltage values and not have a conflict between the two regulation closed loops, a third control closed loop 141 is added which takes the second control closed loop output and used it as a reference V_{mid-ref} to regulate the voltage V_{mid} value by outputting control signal of duty cycle D1 such that the desired value for I_{B2} (−I_{B2-CH-ref}) is achieved while simultaneously achieving the desired value for I_{B1} (+I_{B1-DCH-ref}). After battery 102 reaches its maximum voltage or a desired voltage, a constant voltage (CV) charging control is activated to regulate V_{B2} to V_{B2-ref} until the end of charging condition is reached.

Control Method when battery 102 Discharges into battery 101 (406)—this is analogous to when battery 101 charges from battery 102. A closed control loop 404 regulates I_{B1} during contact current charging (CC) mode of battery 101 to a desired value −I_{B1-CH-ref} by generating duty cycle D1 control signal. A second control closed loop 408 regulates current I_{B2} to a second desired discharging current value +I_{B2-DCH-ref}. However, in order to be able to regulate at two current values and/or with two different battery voltage and not have a conflict between the two regulation closed loops, the third control closed loop 414 is added which takes the second control closed loop output and used it as a reference V_{mid-ref} to regulate the voltage V_{mid} value by outputting control signal of duty cycle D2 such that the desired value for I_{B1} (−I_{B1-CH-ref}) is achieved while simultaneously achieving the desired value for I_{B2} (+I_{B2-DCH-ref}). After battery 101 reaches its maximum voltage or a desired voltage, a constant voltage (CV) charging control is activated to regulate V_{B1} to V_{B1-ref} until the end of charging condition is reached.

The controller 400 switches between the two modes using a signal (D1, D2) that is provided to drivers 202, 203, respectively, to realize the desired number of charge/discharge cycles. The controller uses information such as the efficiency and the capacity values of the batteries to determine how much additional power needs to be provided by the external power source. The controller 400 uses information such as the efficiency and the capacity values of the batteries to determine how much additional power needs to be dissipated using a load or stored in a load (see, 410, 412). The load can be a dissipative load like resistive load or an energy storage device such as supercapacitor pack or battery pack such that this energy is used later as the source.

The controller 400 may use information such as the efficiency and the capacity values of the batteries to determine how much additional power needs to be dissipated using a load or stored in the load. The load may be a dissipative load, such as a resistive load or an energy storage device, such as a supercapacitor pack or battery pack such that the dissipated energy may be used later as a source of energy.

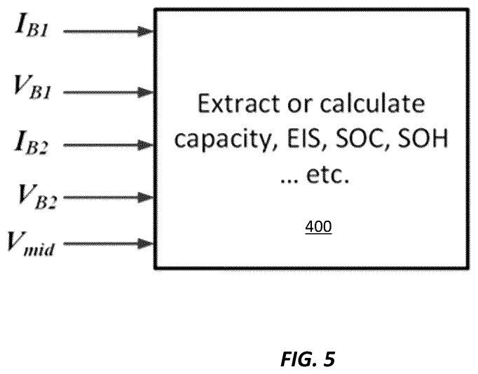

With reference to FIG. 5, the controller 400 may utilize the various current and voltage reference values (−I_{B1-CH-ref}, +I_{B2-DCH-ref}, −I_{B2-CH-ref}, +I_{B1-DCH-ref}, V_{B1-ref}, V_{B2-ref}, V_{mid-ref}) with different types and formats/waveform shapes can be set to record the resulted responses data for characterization and evaluation of the batteries. Recorded repose data can be used to determine capacity, state-of-charge, temperature, EIS, resistance, impedance, state-of-health, dV/dQ, charging current and voltage curves/profiles, discharging current and voltage curves/profiles . . . , etc. These reference values could be DC, AC, time varying, or combination. Time varying references are such as sinusoidal, square, pulses, triangular, sawtooth . . . , etc. A score may be assigned to the characterization of the battery. The controller of FIG. 5 may implement method(s) disclosed in U.S. Pat. No. 10,775,440, which is incorporated herein by reference in its entirety.

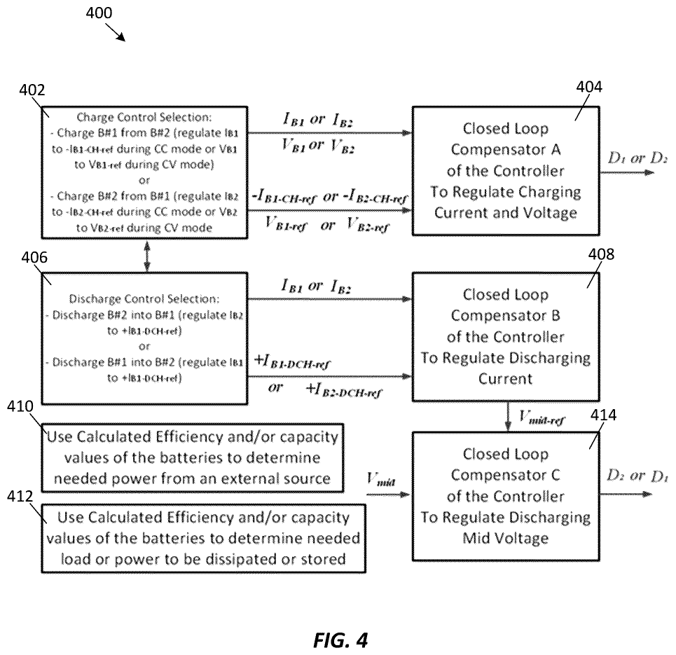

It is noted that the example configuration and control schemes of FIGS. 4 and 5 are provided herein for illustrative purposes. Other configurations and control schemes are contemplated by the present disclosure.

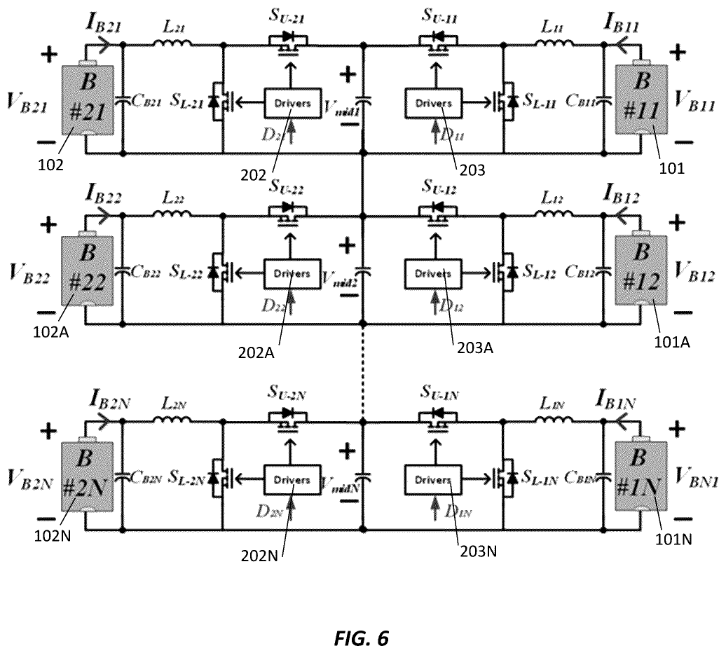

FIG. 6 shows another alternative circuit realization 600, which allows for combination of in series and in parallel of the batteries that are being charged from and discharged to each other (cycled with/between each other) for grading, characterization, capacity or remaining life measurements, and state-of-health estimation.

Thus, the present disclosure describes a system that provides a large decrease/saving in required power/energy consumption and infrastructure for battery grading and evaluation, and also allows batteries such those used for power grid and renewable energy storage and those used as electric vehicles (EV) battery packs to operate such that they can be characterized while charging from and discharging to each other while stationary or mobile (moving). Current facilities require high power installations/infrastructure to be able to process large numbers of batteries at the same time. Thus, a significant reduction in battery grading or evaluation cost and power loss may be achieved.

For example, each battery shown in FIGS. 1, 2, 3, and 6 can be a battery module in an EV battery pack that consists of several modules. They can also be battery cells, modules, or packs in other applications such as those used in uninterruptible power supplies (UPS) systems, other backup power systems, power grid-scale energy storage systems, electric or hybrid-electric boats, electric or hybrid-electric planes, among others.

It should be emphasized that the above-described implementations are merely possible examples of implementations set forth for a clear understanding of the principles of this disclosure. Many variations and modifications may be made to the above-described implementations without departing substantially from the spirit and principles of the disclosure. All such modifications and variations are intended to be included herein within the scope of this disclosure.

What is claimed is:

1. A method for characterizing a plurality of energy storage devices, comprising,
discharging a first storage device into a second storage device to charge the second storage device while measuring discharging characteristics of the first storage device and charging characteristics of the second storage device;
discharging the second storage device into the first storage device to charge the first storage device while measuring charging characteristics of the first storage device and discharging characteristics of the second storage device; and
selectively providing energy from a power source or dissipating energy to a load in accordance with the charging and discharging characteristics of the first storage device and the second storage device.

2. The method of claim 1, further comprising providing energy from a power source, when needed, to the first storage device or the second storage device in order to substitute for lost energy while performing characterizing.

3. The method of claim 1, further comprising dissipating or sending energy to a load, when needed, to the first storage device or the second storage device in order to dissipate lost energy while performing characterizing.

4. The method of claim 1, further comprising dissipating energy from either the first storage device or the second storage device into a load.

5. The method of claim 4, further comprising providing or dissipating energy in accordance with differences in capacities of the first storage device and the second storage device.

6. The method of claim 5, wherein the differences in capacities are due to one of aging or temperature of the first storage device or the second storage device.

7. The method of claim 1, wherein the characterization performed includes capacity, remaining capacity, remaining useful life, state-of-charge, temperature, EIS, resistance, impedance, state-of-health, dV/dQ, charging current and voltage curves/profiles, and/or discharging current and voltage curves/profiles, among others.

8. The method of claim 1, wherein it includes more than two batteries.

9. The method of claim 1, wherein several batteries discharge or charge several other batteries during characterization.

10. An energy device storage characterization system, comprising:
a first driver associated with a first energy storage device to be characterized;
a second driver associated with a second energy storage device to be characterized; and
a controller that switches between a plurality of modes that determines a flow of energy among the first energy storage device, the second energy storage device a power source, and a load.

11. The energy device storage characterization system of claim 10, wherein the plurality of modes include a first mode of operation where the first energy storage device discharges into the second energy storage device, a second mode of operation where the second storage device discharges into the first storage device, a third mode of operation where none of the first energy storage device and the second energy storage are discharging or charging, and a fourth mode of operation where one or more of the first energy storage device and the second energy storage are charging from the power source or discharging into the load.

12. The system of claim 11, wherein in the first mode a first closed control loop regulates a first current to the second storage device during a constant current (CC) charging mode of the second storage device by controlling a duty cycle of the second driver, a second control loop regulates a second current from the first energy storage device, and a third control closed loop controls the duty cycle of the first driver to regulate the first current and the second current to account for differences between a voltage of the first energy storage device and the second energy storage device until an end of charging condition is reached.

13. The system of claim 11, wherein in the second mode, a first closed control loop regulates a first current to the first storage device during a constant current (CC) charging mode of the first storage device by controlling a duty cycle of the first driver, a second control loop regulates a second current from the second energy storage device, and a third control closed loop controls the duty cycle of the second driver to regulate the first current and the second current to account for differences between a voltage of the first energy storage device and the second energy storage device until an end of charging condition is reached.

14. The system of claim 11, wherein a controller switches between modes of operation to achieve a desired number of charge/discharge cycles of the first energy storage device and the second energy storage device.

15. The system of claim 14, wherein the controller uses efficiency and capacity information of the energy storage devices to determine how much additional power needs to be provided by an external power source or dissipated to an external load.

16. The system of claim 11, wherein the controller receives current and voltage reference values to perform the characterization of the energy storage devices.

17. The system of claim 11, wherein current and voltage references for discharging and charging modes of operation can be of different forms or shapes such as DC, AC, combination, and/or time varying such as sinusoidal, square, pulses, triangular, and sawtooth.

18. The system of claim 17, wherein a frequency of the current and voltage references for discharging and charging modes of operation can be varied.

19. The system of claim 17, wherein the first energy storage device and the second energy storage are batteries, and wherein time varying voltage and current responses of the batteries to the time varying current or voltage references is measured and used to calculate an impedance of batteries as a battery charges and a battery discharges.

20. The system of claim 17, further comprising additional energy storage devices, wherein the first energy storage device, the second energy storage are batteries and additional storage devices are batteries, and wherein several of the batteries discharge or charge several of other batteries during characterization.
